(19) United States
(12) Patent Application Publication
(10) Pub. No.: US 2009/0188105 A1
(43) Pub. Date: Jul. 30, 2009

(54) SLIM BATTERY PACKAGING METHOD

(76) Inventors: Ming-Chin CHIEN, Taoyuan County (TW); Hsin-Liang CHEN, Keelung City (TW)

Correspondence Address: Joe McKinney Muncy, PO Box 1364, Fairfax, VA, 22038-1364, US

(21) Appl. No.: 12/021,153

(22) Filed: Jan. 28, 2008

(51) Int. Cl. H01M 6/00; H01M 2/02

(52) U.S. Cl. 29/623.4; 156/311

(57) ABSTRACT

The present invention discloses a slim battery packaging method, which comprising steps: preparing at least one slim battery and an electronic substrate to be connected to the slim battery, wherein the slim battery and the electronic substrate respectively have electric-connection terminals corresponding to each other; joining the electric-connection terminals of the slim battery and the electronic substrate with a conductive adhesive; applying a thermosetting temperature to the electric-connection terminals with a hot-press device to transfer the thermosetting temperature to the conductive adhesive and cure the conductive adhesive; and providing a cooling device in the preceding step to inhibit the conduction of the thermosetting temperature to a non-electric-connection terminal area of the slim battery for maintaining the performance of the slim battery.

### FIELD OF THE INVENTION

The present invention relates to a slim battery packaging method, particularly to a slim battery packaging method, which can inhibit the conduction of conductive-adhesive thermosetting temperature.

### BACKGROUND OF THE INVENTION

The Smart Card, also called ICC (Integrated Circuit Card), is a plastic card where an IC chip is embedded. As IC chips have the storage, encryption and processing capability of data, Smart Card are used in many fields, such as banking, communication, trade, identification, etc., in form of credit cards, electronic wallets, and identity cards, etc. Generally, a user needs an independent data reader to read the data inside a Smart Card. However, several types of Smart Cards with a display device have been developed now, such as those disclosed in published US patent applications of No. 20040129450 and No. 20030062830. Therefore, a user can directly learn the data inside a Smart Card from the display device on the Smart Card without using a data reader. The display-containing Smart Card needs a power source to drive the circuits on the electronic substrate and display device thereof. A high energy density slim battery is usually adopted as the power source mentioned above to match the dimensions of a Smart Card.

At present, a slim battery is usually in form of a metal hydride battery (such as the Ni-MH battery), a nickel-cadmium battery, a lithium battery or a lithium ion battery, which may possess a solid electrolyte, a liquid electrolyte or a polymer electrolyte. For the related technologies, please refer to published US patent applications of No. 20040253520, No. 20040229127, No. 20040229118, No. 20050239917, and issued U.S. Pat. No. 5,888,672 and No. 6,451,480. Before a slim battery is packaged in a Smart Card, the anode and cathode electrodes of the slim battery need connecting to the corresponding positions of an electronic substrate so that the power from two electrodes of the slim battery can drive the circuits on the electronic substrate. Pressure-sensitive conductive adhesive or thermosetting conductive adhesive are usually applied to the terminals of two electronic devices to join them together. Pressure-sensitive adhesive can be easily applied at ambient temperature but has a poor adhesion capability, which may cause misalignment or disconnection between a slim battery and an electronic substrate when used in the package of the slim battery and the electronic substrate. In the application of thermosetting conductive adhesive, ACF (Anisotropic Conductive Film) is usually adopted. The application of ACF to slim batteries can be found in a R.O.C Patent Pub. No. 200627696. ACF has the characteristics of unidirectional electric conductivity and reliable adhesion and is widely used in the assembly process of electronic industry. However, the thermosetting of ACF needs very high temperature and pressure. Generally, the thermosetting pressure is 290-435 psi, and the thermosetting temperature is 160-200° C., or even as high as 250° C. Some conventional slim batteries, such as those disclosed in the published US patent applications of No. 20040253520, No. 20040229127 and No. 20040229118, can only withstand 125-140° C. and 200-250 psi for 5-15 minutes, which are much lower than the thermosetting temperature and pressure of ACF. ACF has the advantage of reliable adhesion. However, the high temperature applied to the thermosetting positions for ACF will be conducted to a nearby slim battery, cause the electric damage of the slim battery and result in insufficient output power when ACF is directly used in the joining process of a slim battery and an electronic substrate.

### SUMMARY OF THE INVENTION

The primary objective of the present invention is to solve the conventional problem: the thermosetting temperature causes the electric damage of a slim battery when a thermosetting conductive adhesive is used to join the slim battery and an electronic substrate. The present invention proposes a slim battery packaging method, which comprises: (a) a material preparation step: including preparing at least one slim battery and preparing an electronic substrate to be connected with the slim battery, wherein the slim battery and the electronic substrate respectively have electric-connection terminals corresponding to each other; (b) an adhesion step: joining the electric-connection terminals of the slim battery and the electronic substrate with a conductive adhesive; (c) a thermosetting step: applying a thermosetting temperature to the electric-connection terminals with a hot-press device to transfer the thermosetting temperature to the conductive adhesive and cure the conductive adhesive; and (d) a temperature inhibition step: providing a cooling device in the preceding step to inhibit the thermosetting temperature conduction to the non-electric-connection terminal area of the slim battery for maintaining the performance of the slim battery. The abovementioned conductive adhesive may be a solid conductive adhesive tape, a liquid conductive glue, or a tin paste, wherein the solid conductive adhesive tape is the best choice. The abovementioned slim battery may be a lithium battery, a lithium ion battery, or a polymer electrolyte battery.

The cooling device in step (d) may be an air cooling device or a water cooling device, but a water cooling device is preferred. The cooling device is equipped with a temperature sensor, which contacts the electric-connection terminals of the slim battery and the electronic substrate or the non-electric-connection terminal area. The cooling device can keep the non-electric-connection terminal area at a temperature below 60° C., preferably below 22° C. In step (a), the electronic substrate may be electrically connected with a display screen before packaging, and the display screen is an electrophoresis display device. The present invention applies to all the products needing a slim battery, including: Smart Cards and RFID (Radio Frequency Identification) tags.

In the thermosetting step of the slim battery packaging method of the present invention, a cooling device is used to inhibit the heat conduction from the electric-connection terminals to the slim battery to prevent the slim battery from electric damage. Therefore, the present invention can promote the yield of electronic products containing a slim battery.

### BRIEF DESCRIPTION OF THE DRAWINGS

FIG. 1 is a flowchart of a slim battery packaging method according to one preferred embodiment of the present invention.

FIG. 2 is a diagram schematically showing a slim battery packaging method according to one preferred embodiment of the present invention.

FIG. 2 is a diagram schematically showing a slim battery packaging method using an air cooing device according to another preferred embodiment of the present invention.

FIG. 4 is a diagram schematically showing the application of the present invention to the fabrication of a Smart Card with a display screen.

### DETAILED DESCRIPTION OF THE PREFERRED EMBODIMENTS

The technical contents of the present invention will be described in detail in cooperation with the drawings below.

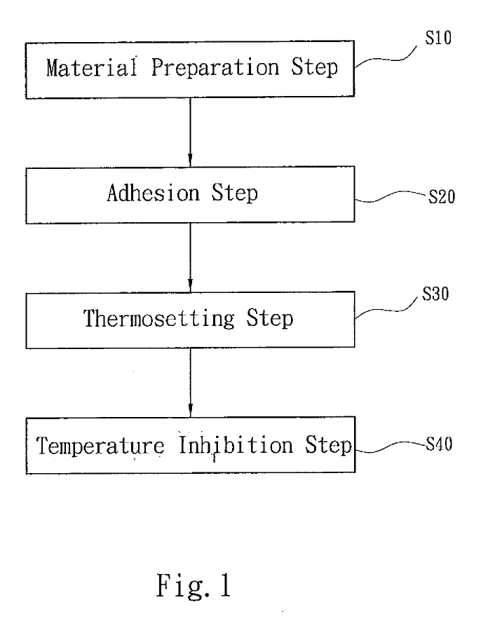

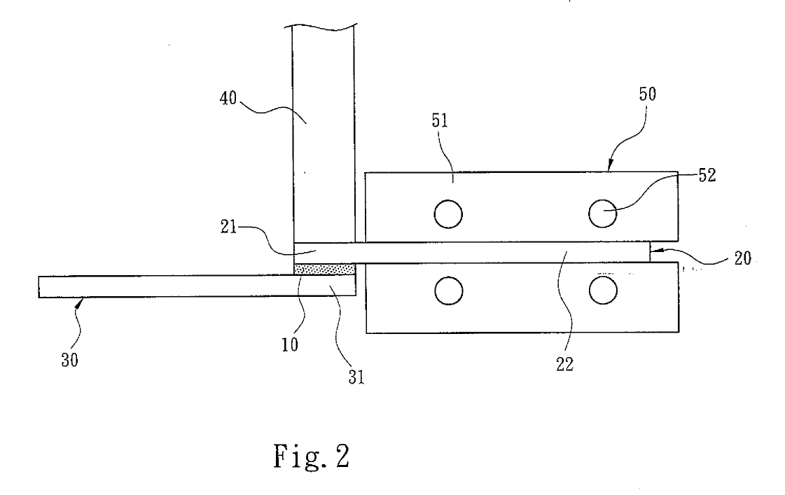

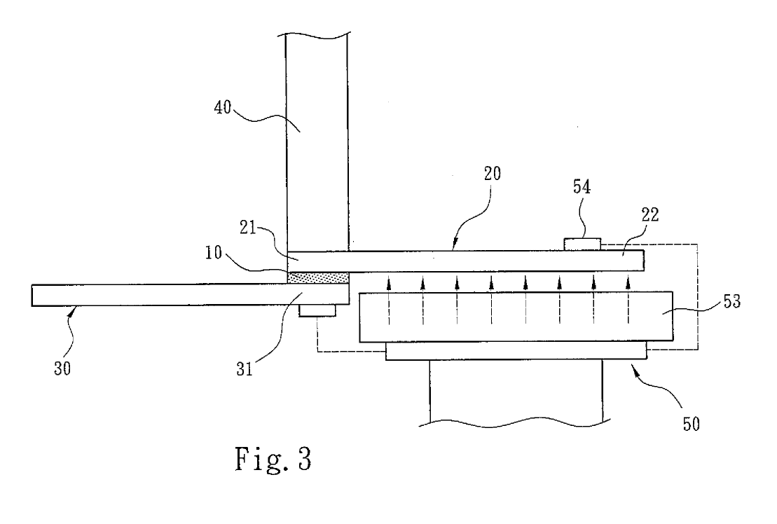

Refer to FIG. 1 and FIG. 2 respectively a flowchart of a slim battery packaging method and a diagram schematically showing the hot-press process according to one preferred embodiment of the present invention. The present invention proposes a slim battery packaging method, which comprises:

(a) Material Preparation Step S10: including preparing at least one slim battery and preparing an electronic substrate to be connected with the slim battery, wherein the slim battery and the electronic substrate respectively have electric-connection terminals corresponding to each other;

(b) Adhesion Step S20: joining the electric-connection terminals of the slim battery and the electronic substrate with a conductive adhesive;

(c) Thermosetting Step S30: applying a thermosetting temperature to the electric-connection terminals with a hot-press device to transfer the thermosetting temperature to the conductive adhesive and cure the conductive adhesive; and

(d) Temperature Inhibition Step S40: providing a cooling device in the preceding step to inhibit the thermosetting temperature conduction from the electric-connection terminals to the non-electric-connection terminal area of the slim battery for maintaining the performance of the slim battery.

The present invention adopts a conductive adhesive 10 as a bonding agent to join a slim battery 20 and an electronic substrate 30 together. The slim battery 20 and the electronic substrate 30 respectively have electric-connection terminals 21 and 31 corresponding to each other. The slim battery 20 and the electronic substrate 30 are placed in appropriate positions and aligned to each other. The conductive adhesive 10 is applied onto the electric-connection terminals 21 and 31 to make them stick to each other. The conductive adhesive 10 may be a solid conductive adhesive tape, a liquid conductive glue, or a tin paste, wherein the solid conductive adhesive tape is the best choice. The solid conductive adhesive tape may be a z-axis ACF (Anisotropic Conductive Film). The tin paste may contain a tin-lead alloy, a tin-silver-copper alloy, or tin metal. In the present invention, the slim battery may be a lithium battery, a lithium ion battery, or a polymer electrolyte battery.

After the slim battery 20 has been stuck to the electronic substrate 30 with the conductive adhesive 10, a thermosetting temperature is applied to the electric-connection terminals 21 and 31 with a hot-press device 40. Heat will be transmitted to the conductive adhesive 10 to thermally cure the conductive adhesive 10. The applied thermosetting temperature is between 100 and 260° C., preferably between 160 and 190° C. The duration of heating is between 10 and 20 seconds. In addition to being transmitted to the electric-connection terminals 21 and 31, heat from the hot-press device 40 may also be transmitted to the non-electric-connection terminal area 22. The non-electric-connection terminal area 22 contains some type of electrolyte, and heat may affect the electric performance thereof and degrade the electricity supply capability of the slim battery 20. Therefore, when the hot-press device 40 heats the electric-connection terminals 21 and 31, a cooling device 50 is used to cool the non-electric-connection terminal area 22 and keeps the non-electric-connection terminal area 22 at a temperature below 60° C., preferably below 22° C. Via inhibiting the transmittal of the thermosetting temperature, the present invention can ensure the performance of the slim battery 20. Therefore, the hot-press device 40 provides the thermosetting temperature for the electric-connection terminals 21 and 31, and the cooling device 50 inhibits the heat transference from the electric-connection terminals 21 and 31 to the non-electric-connection terminal area 22. The cooling device 50 only cools the non-electric-connection terminal area 22 to prevent the slim battery 20 from being damaged by heat but does not affect the hot-press device 50 heating the electric-connection terminals 21 and 31. Thus, the conductive adhesive 10, which is applied onto the electric-connection terminals 21 and 31, is cured at an appropriate thermosetting temperature, and the slim battery 20 and the electronic substrate 30 are joined together.

In this embodiment, the cooling device 50 is a water cooling device, which has two cooling members 51 respectively contacting two sides of the non-electric-connection terminal area 22 of the slim battery 20, wherein cooling water 52 circulates inside the cooling members 51 to rapidly dissipate heat out of the non-electric-connection terminal area 22 lest heat from the hot-press device 40 accumulate in the slim battery 30. The user can regulate the flowrate or temperature of cooling water 52 to control the heat-dissipation effect. The cooling member 51 of the cooling device 50 can selectively only contact one side of the non-electric-connection terminal area 22 to dissipate heat therefrom.

Refer to FIG. 3 for another embodiment, wherein the cooling device 50 is an air cooling device, which includes a cooling air generator 53. The cooling air generator 53 is arranged at a position opposite to the slim battery 20 and outputs cooling air to cool the slim battery 20. The cooling air generator 53 can regulate the wind speed and temperature of the cooling air to control the heat-dissipation effect. In addition to the abovementioned water cooling device and air cooling device, the cooling device 50 can also be realized by a thermoelectric cooling chip or other cooling devices, which can cool the non-electric-connection terminal area 22 of the slim battery 20.

Also refer to FIG. 3. To enable the user to learn the temperature of the hot-press environment, the cooling device 50 has temperature sensors 54. The temperature sensors 54 are arranged in the electric-connection terminals 21 and 31 and/or the non-electric-connection terminal area 22. Via the temperature sensors 54, the user can learn whether the electric-connection terminals 21 and 31 have reached the desired thermosetting temperature, or whether the temperature of the non-electric-connection terminal area 22 is increased by the heat from the hot-press device 50, or even whether the cooling device 50 inhibits the rise of the temperature of the non-electric-connection terminal area 22. Based on the information obtained by the temperature sensors 54, the cooling device 50 regulates cooling conditions to optimize cooling effect.

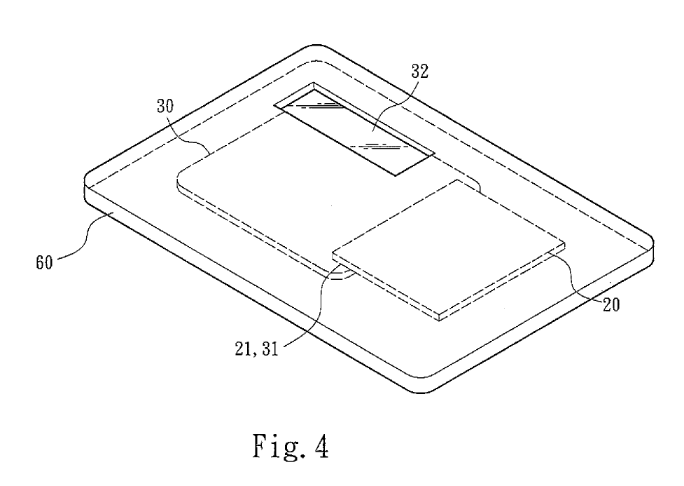

The slim battery packaging method of the present invention applies to various electronic products 60 using a slim battery, including: the Smart Cards, the RFID tags, and other slim electronic devices. Refer to FIG. 4 for the application of the present invention to the fabrication of a Smart Card with a display screen. In Material Preparation Step (a), the electronic substrate 30 is electrically coupled to a display screen 32 before packaging, and the display screen 32 may be an electrophoresis display device. The display screen 32 can present the data stored or processed by the electronic substrate 30. Therefore, the user needn't use an additional data reader to learn the information stored in the electronic substrate 30. When the electronic substrate 30 together with the display screen 32 is applied to a Smart Card, the owner can directly read the information inside the Smart Card, such the dates, the identity number, and the remaining credit.

In conclusion, the present invention uses the conductive adhesive 10 to effectively join together the slim battery 20 and the electronic substrate 30 in the electronic product 60 and uses the cooling device 50 to cool the non-electric-connection terminal area 22 lest the heat from the hot-press device 40 electrically damage the non-electric-connection terminal area 22 via the electric-connection terminals 21 and 31. The cooling device 50 only cools the non-electric-connection terminal area 22 but does not affect the hot-press device 40 heating the electric-connection terminals 21 and 31. When the conductive adhesive 10 is heated to a thermosetting temperature, the slim battery 20 and the electronic substrate 30 are securely joined. Via the cooling device 50 that can inhibit the conduction of the heat generated by the hot-press device 40, the present invention can realize the packaging method which uses the thermosetting conductive adhesive 10 as the bonding agent to join the slim battery 20 and the electronic substrate 30 without the conventional problem that the thermosetting temperature damages the electric performance of the slim battery 20.

The preferred embodiments described above are only to exemplify the present invention but not to limit the scope of the present invention. Therefore, any equivalent modification or variation according to the spirit of the present invention is to be also included within the scope of the present invention.

What is claimed is:

1. A slim battery packaging method comprising:
a material preparation step: including preparing at least one slim battery and preparing an electronic substrate to be connected with the slim battery, wherein said slim battery and said electronic substrate respectively have electric-connection terminals corresponding to each other;
an adhesion step: joining said electric-connection terminals of said slim battery and said electronic substrate with a conductive adhesive;
a thermosetting step: applying a thermosetting temperature to said electric-connection terminals with a hot-press device to transfer said thermosetting temperature to said conductive adhesive and cure said conductive adhesive; and
a temperature inhibition step: providing a cooling device in the preceding step to inhibit the conduction of said thermosetting temperature to a non-electric-connection terminal area of said slim battery for maintaining the performance of said slim battery.

2. The slim battery packaging method according to claim 1, wherein said thermosetting temperature in said thermosetting step is between 100 and 260° C.

3. The slim battery packaging method according to claim 2, wherein said thermosetting temperature in said thermosetting step is between 160 and 190° C.

4. The slim battery packaging method according to claim 1, wherein in said thermosetting step, the duration of hot pressing is between 10 and 20 seconds.

5. The slim battery packaging method according to claim 1, wherein said conductive adhesive is preferably a solid conductive tape.

6. The slim battery packaging method according to claim 5, wherein said solid conductive tape is a z-axis anisotropic conductive film.

7. The slim battery packaging method according to claim 1, wherein said conductive adhesive is a liquid conductive glue.

8. The slim battery packaging method according to claim 1, wherein said conductive adhesive is a tin paste.

9. The slim battery packaging method according to claim 8, wherein a material of said tin paste is selected from a group consisting of a tin-lead alloy, a tin-silver-copper alloy and tin metal.

10. The slim battery packaging method according to claim 1, wherein said slim battery is a lithium battery, a lithium ion battery, or a polymer electrolyte battery.

11. The slim battery packaging method according to claim 1, wherein in said material preparation step, said electronic substrate is electrically connected to a display screen firstly.

12. The slim battery packaging method according to claim 11, wherein said display screen is an electrophoresis display device.

13. The slim battery packaging method according to claim 1, wherein said cooling device is preferably a water cooling device.

14. The slim battery packaging method according to claim 1, wherein said cooling device is an air cooling device.

15. The slim battery packaging method according to claim 1, wherein said cooling device has at least one thermoelectric cooling chip.

16. The slim battery packaging method according to claim 1, wherein said temperature inhibition step is to keep said non-electric-connection terminal area at a temperature below 60° C.

17. The slim battery packaging method according to claim 16, wherein said non-electric-connection terminal area is kept at a temperature below 22° C.

18. The slim battery packaging method according to claim 1, wherein said cooling device has a temperature sensor.

19. The slim battery packaging method according to claim 18, wherein said temperature sensor is arranged in said electric-connection terminal.

20. The slim battery packaging method according to claim 18, wherein said temperature sensor is arranged in said non-electric-connection terminal area.

21. The slim battery packaging method according to claim 1, which is used to fabricate an electronic product.

22. The slim battery packaging method according to claim 21, wherein said electronic product is a Smart Card or a RFID (Radio Frequency Identification) tag.
